(19) United States
(12) Patent Application Publication
(10) Pub. No.: US 2019/0353886 A1
(43) Pub. Date: Nov. 21, 2019

(54) METHOD FOR GENERATING A THREE-DIMENSIONAL MODEL OF A SAMPLE IN A DIGITAL MICROSCOPE AND A DIGITAL MICROSCOPE

(71) Applicant: CARL ZEISS MICROSCOPY GMBH, Jena (DE)

(72) Inventors: Pavlos ILIOPOULOS, Weimar (DE); Alexander GAIDUK, Jena (DE)

(21) Appl. No.: 16/473,793

(22) PCT Filed: Jan. 3, 2018
(86) PCT No.: PCT/EP2018/050122

§ 371 Date: Jun. 26, 2019

(30) Foreign Application Priority Data
Jan. 9, 2017 (DE) 10 2017 100 262.6

(51) Int. Cl. G02B 21/36; G06T 17/00; G02B 21/26; G02B 21/24

(52) U.S. Cl. CPC G02B 21/367; G06T 17/00; G06T 2200/08; G02B 21/241; G02B 21/26

(57) ABSTRACT

The present invention relates to a method for generating a three-dimensional model of a sample (09) using a microscope (01), comprising the following steps: specifying a perspective for recording images of at least one area of the sample (09), wherein the perspective is specified by the angle and the position of the optical axis of the objective lens relative to a sample, and by the angular distribution of illumination radiation relative to the sample; recording multiple individual images of the sample (09) at various focus positions from the specified perspective; repeating the preceding steps for the at least one area of the sample (09) with at least one other different perspective; computing a three-dimensional model of the area of the sample (09) from the recorded individual images of the area of the sample (09). The invention further relates to a digital microscope that is configured for carrying out the method according to the invention.

### BACKGROUND OF THE INVENTION

The present invention relates to a method for generating a three-dimensional model of a sample in a digital microscope. The invention further relates to a digital microscope with which the method according to the invention may be carried out.

In digital microscopes, it is known that electronic image conversion takes place, and the recorded image in the form of digital data is further processed and displayed on an electronic image rendering device.

Generation of three-dimensional models of an observed sample is an important task in microscopy. In the detection methods and reconstruction algorithms, for example focus variations, used thus far for 3D reconstruction, there is a large number of concealed areas in which information concerning the object being observed under the microscope is not available due to the limitations in the image acquisition methods.

A method for generating three-dimensional information concerning an object in a digital microscope is described DE 10 2014 006 717 A1. In this method, an image for one focus position in each case is initially recorded. The image together with the associated focus position is stored in an image stack. The preceding steps are repeated at various focus positions. The individual images are used to compute an image with an extended depth of field (EDoF image). A number of pixel defects are detected in the process of computing the EDoF image. Lastly, an elevation map or a 3D model is computed.

EP 2 793 069 A1 discloses a digital microscope having an optical unit and a digital image processing unit that are situated on a microscope stand. A further component of the digital microscope is an image sensor for detecting an image of a sample to be placed on a sample stage. The digital microscope also includes at least one first monitoring sensor for observing the sample, the sample stage, the optical unit, or a user, as well as a monitoring unit. Data of the monitoring sensor are evaluated in an automated manner in the monitoring unit and used for automatically controlling the digital microscope. The digital microscope may have a second monitoring sensor that is situated at a different location than the first monitoring sensor. The data of both monitoring sensors are processed in the monitoring unit to provide three-dimensional overview information. In addition, the data detected by the monitoring sensors may be used for rough positioning of the sample stage or for automatically setting a focus of the objective lens.

EP 1 333 306 B1 describes a stereomicroscopy method and a stereomicroscope system for generating stereoscopic representations of an object, so that a spatial impression of the object results when the representations are observed by a user. For this purpose, various representations of the object from different viewing directions onto the object are provided to the left eye and to the right eye of the user. The stereomicroscope system includes, among other things, a detector assembly with two cameras that are spaced apart from one another in such a way that each camera can record an image from an area of a surface of the object. Due to the spacing between the two cameras, the area is recorded from various viewing angles. Based on the data supplied by the cameras, a three-dimensional data model of the observed object may be generated by use of suitable software.

Various methods are known for generating three-dimensional models from multiple images. Makoto Kimura and Hideo Saito describe 3D reconstruction by means of epipolar geometry in the technical article “3D reconstruction based an epipolar geometry” in IEICE Transactions on Information and Systems, 84.12 (2001): 1690-1697. Epipolar geometry is a model from geometry that depicts the geometric relationships between various camera images of the same object.

In image processing, the known RANdom SAmple Consensus (RANSAC) algorithm is used for determining homologous points between two camera images. The two pixels generated by a single object point in the two camera images are homologous. The result of automatic analysis usually contains a fairly large number of misallocations. The aim is to eliminate misallocations by use of RANSAC. In epipolar geometry, RANSAC is used to determine the fundamental matrix, which describes the geometric relationship between the images. The use of RANSAC in epipolar geometry is described in the publication “Automatic Estimation of Epipolar Geometry” by the Department of Engineering Science, The University of Oxford (http://www.robots.ox.ac.uk/˜az/tutorials/tutorialb.pdf).

Scharstein, D. and Szeliski, R. describe taxonomy and evaluation of stereo correspondence algorithms in the technical article “A taxonomy and evaluation of dense two-frame stereo correspondence algorithms” in International Journal of Computer Vision, 47(1): 7-42, May 2002.

Frankot, R. T. and Chellappa, R. describe the integrability of shading algorithms in the technical article “A method for enforcing integrability in shape from shading algorithms. Pattern Analysis and Machine Intelligence” in IEEE Transactions, 10(4): 439-451, 1988.

WO 2015/185538 A1 describes a method and software for computing three-dimensional surface topology data from two-dimensional images recorded by a microscope. The method requires at least three two-dimensional images, which are recorded at three different observation angles between the sample plane and the optical axis. The preferred observation angles are between 0.5° and 15°. The images must contain contrasting changes (color, inclination). According to the method, the sample inclination and the sample position are determined in conjunction with the depth of field determination. The described examples use image data recorded using scanning electron microscopes.

US 2016/091707 A discloses a microscope system for surgery. Images of samples may be recorded at various observation angles/perspectives by use of the system. The recorded image data are used to generate three-dimensional images of the sample. The system utilizes a spatial light modulator for varying the illumination angles or detection angles. The selectivity of the angles is limited by the opening angles of the optical systems used for the detection and illumination. Options for achieving larger angles are not discussed. The light modulator is situated in the rear focal plane or in the conjugated plane that is equivalent thereto.

U.S. Pat. No. 8,212,915 B1 discloses a method and a device for focusing images that are observed through microscopes, binoculars, and telescopes, making use of the focus variation. The device utilizes a relay lens assembly for a wide-field imaging system. The assembly has a lens with an adjustable focal length, such as a fluid lens. Stereoscopic EDoF images may be generated by providing a camera and relay lens assembly in the vicinity of the two eyepieces.

The commercially available product “3D WiseScope microscope,” manufactured by SD Optics, Inc., allows rapid generation of macroscopic and microscopic images having an extended depth of field. The product includes, among other things, an LED ring light, a coaxial light, a transmitted light illuminator, a cross table, objective lenses with 5×, 10×, 20×, and 50× magnification, and a manual focus. The focus may be changed at a frequency of 1 to 10 kHz and higher. A mirror array lens system, referred to as a MALS module, is used to achieve EDoF functionality. Details about these systems are disclosed in Published Unexamined Patent Applications WO 2005/119331 A1 and WO 2007/134264 A1, for example.

Proceeding from the prior art, the object of the present invention is to provide a method for generating a three-dimensional model of a sample with greater accuracy, fewer concealed areas, and greater depth of field. In particular, the aim is to be able to achieve more comprehensive and robust 3D models. A further aim is to provide a microscope with which the method may be carried out.

### Object of the Invention

The object is achieved according to the invention by a method according to claim 1 and a digital microscope according to independent claim 14.

The method according to the invention for generating a three-dimensional model of a sample in a digital microscope comprises the following described steps. Initially, multiple individual images of the sample are recorded with one perspective at various focus positions. Such a sequence of images that has been recorded in different focus planes is also referred to as a focus stack. The individual images encompass at least one area of the sample. A perspective is specified by the angle and the position of the optical axis of the objective lens relative to the sample, and by the angular distribution of the illumination radiation relative to the sample. The first-mentioned steps are subsequently repeated at least once for the specified area of the sample, with a different perspective. The angle and/or the position of the optical axis of the objective lens relative to the sample may be changed in order to change the perspective. It is also possible to change only the angle and/or the position of the illumination radiation relative to the sample. The parameters of the objective lens and the illumination may also both be changed. In this way, individual images of an area of the sample are recorded with at least two different perspectives. A three-dimensional model of the sample or of the area of the sample is subsequently computed based on the recorded individual images of the area of the sample.

According to one advantageous embodiment, in the computation of the three-dimensional model, initially an image with an extended depth of field or an elevation map may be computed in each case from the individual images of the area that are recorded for each specified perspective. Each computed image with an extended depth of field or the computed elevation map together with information concerning the perspective used is stored in a memory. The three-dimensional model of the area of the sample is subsequently computed from the computed images with an extended depth of field or the elevation map.

The method may be carried out for the entire sample or for multiple areas of the sample. A three-dimensional model of the sample may then be determined from the three-dimensional models of the individual areas. For this purpose, three-dimensional models of adjacent areas that overlap in the edge region are preferably determined.

The order of the steps of the method may be varied.

In one embodiment of the invention, an optical actuator that is designed as a microsystem with mechanically movable micromirrors for recording an extended depth of field may be used for rapidly recording focus stacks. The optical actuator may be designed as a micromirror array. The micromirror array forms an optical element whose optical properties may be changed very quickly. In one variant of this embodiment, the micromirror array forms a Fresnel lens whose focal length may be varied.

Known algorithms for 3D reconstruction from two-dimensional images, based on stereogrammetry or epipolar geometry, for example, are used to compute the three-dimensional model of the sample. These algorithms are well known to those skilled in the art, so that at this point the algorithms are discussed only briefly, and detailed explanations may be dispensed with. In the 3D reconstruction by means of epipolar geometry, fitting points between the recorded images are used to compute the fundamental matrix between the camera positions and for the metric reconstruction of the sample. The fitting points may be input either by the user (user-assisted) or automatically via algorithms such as RANSAC. The fundamental matrix may also be precomputed during the calibration of the microscope device. The 3D reconstruction by means of stereogrammetry is similar to human stereoscopic vision. In this regard, perspective distortions in the images, which are extracted from two or more pixels, are utilized.

A significant advantage of the method according to the invention is that the accuracy of the present three-dimensional model resulting from the method according to the invention may be improved, and the number of concealed areas may be reduced. There is a dependency on the number of perspectives. As the number of perspectives increases, the accuracy of the three-dimensional model increases, while the number of concealed areas decreases. For this reason, the method should preferably use more than two perspectives to be able to achieve the most accurate three-dimensional model possible. In microscopy, the depth of field of the recorded images is inherently limited, and is usually in the micron or nanometer range. As a result, known three-dimensional reconstruction methods based on macroscopic applications often give unsatisfactory results. For this reason, individual images of the sample are recorded at various focus positions in the method according to the invention. As a result, images with an extended depth of field or elevation maps are available for computing the three-dimensional model of the sample. By use of the image data thus obtained, proven techniques and algorithms from computer vision applications of the macroworld may be used for generating high-quality three-dimensional models, now also in the field of microscopy.

According to one particularly preferred embodiment, the incorrectly computed pixels of the three-dimensional model of the sample are eliminated by applying an estimation algorithm. The RANSAC algorithm, for example, or a similar algorithm may be used as an estimation algorithm. The quality of the three-dimensional model may be further improved by eliminating the defective pixels.

Several options are available for achieving the various perspectives. One advantageous design uses a sample stage that is displaceable in the X and/or Y direction and/or rotatable or tiltable. In the simplest case, the sample stage may be brought into the desired position manually. Use of a motorized sample stage has proven advantageous in particular with regard to optimizing method sequences.

Alternatively, the various perspectives may also be achieved by swiveling a microscope stand, an image sensor, or an optical axis. The swiveling takes place either manually or by means of a suitable drive device.

According to one particularly preferred embodiment, the various perspectives are designed as illumination perspectives. The various illumination perspectives are preferably achieved by sequential illumination of the sample. An illumination source designed as a ring light illuminator, for example, may be used for this purpose. The ring light illuminator preferably includes multiple illumination means, preferably in the form of LEDs, that are situated at the same or different distances from the sample. For each illumination perspective, the position of the illumination source relative to the sample remains unchanged during recording of the individual images. The illumination means may be controlled independently of one another. The horizontal angle for illuminating the sample may be varied by selecting the illumination means preferably from 0 to 360°. The shading detected in the recorded images is preferably used for computing the three-dimensional model of the sample.

A particularly accurate three-dimensional model of the sample with few concealed areas may be implemented by combining the various methods for achieving the different perspectives and the various algorithms for computing the three-dimensional models from the computed images with an extended depth of field or the computed elevation maps. For this purpose, at least two three-dimensional models of the sample are computed, wherein the various perspectives for each of the three-dimensional models are achieved in different ways, and/or a different algorithm is used for computing each of the three-dimensional models. The results of each algorithm are preferably supplied to an estimation algorithm, such as RANSAC, in order to eliminate incorrectly computed pixels. Lastly, the computed three-dimensional models are combined into an end model. In this regard, a weighted assessment of the computed three-dimensional pixels of the end model has proven advantageous. The different weighting of the determined pixels may take place, for example, based on the algorithm used in each case for computing the particular pixel, the illumination that is present, the selected magnification level, and other objective features.

The digital microscope according to the invention is characterized in that it is configured for carrying out the described method. The digital microscope may thus be equipped with a pivotable microscope stand to adjust the visual field. An optical unit of the microscope is preferably height-adjustable in order to achieve various focus positions. Alternatively or additionally, the digital microscope may be equipped with a sample stage that is displaceable in the X and/or Y direction and/or rotatable and/or tiltable. Also suitable are digital microscopes with illumination modules whose illumination direction and illumination angle may be controlled to allow sequential illumination of the sample.

### DESCRIPTION OF THE DRAWINGS

Further particulars and refinements of the invention result from the following description of preferred embodiments, with reference to the drawings, which show the following:

FIG. 1 shows a schematic illustration of a first embodiment of a digital microscope that is usable for carrying out a method according to the invention;

FIG. 2 shows a schematic illustration of a second embodiment of the digital microscope that is usable for carrying out the method according to the invention;

FIG. 3 shows a schematic illustration of a third embodiment of the digital microscope that is usable for carrying out the method according to the invention; and

FIG. 4 shows three switching states of a ring light illuminator of the digital microscope that is usable for carrying out the method according to the invention.

### DETAILED DESCRIPTION OF THE INVENTION

Although the particulars illustrated in the figures are known per se from the prior art, the devices in question may be operated in a novel way and with a broader functional scope by application of the invention.

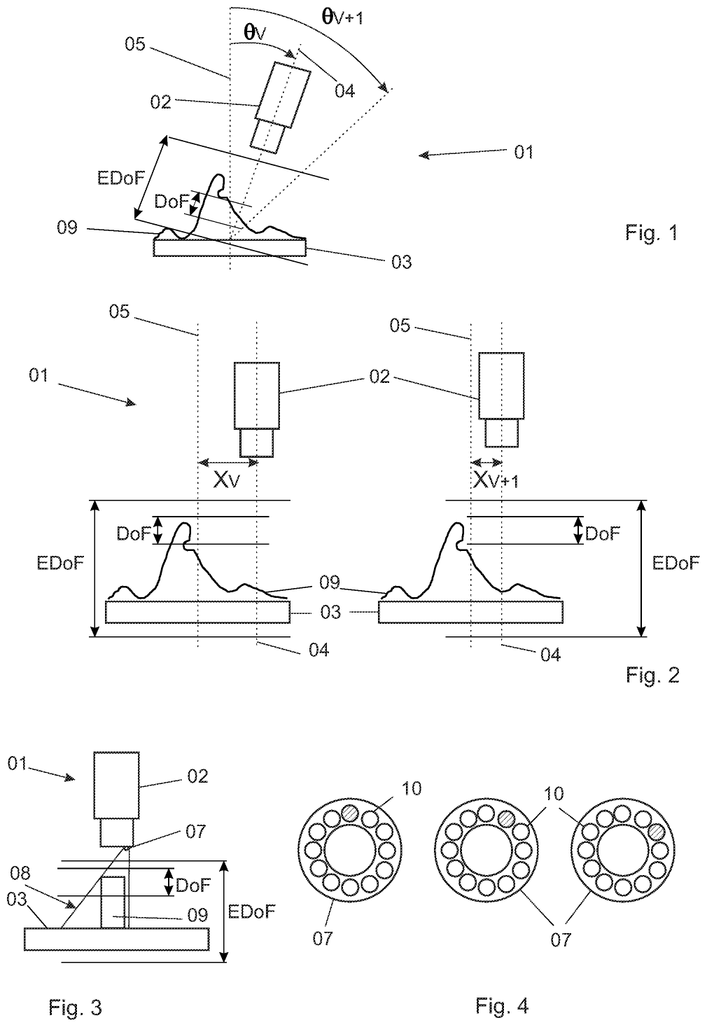

FIG. 1 shows a schematic illustration of a first embodiment of a digital microscope 01 that is usable for carrying out a method according to the invention. FIG. 1 illustrates an optical unit 02, and a sample stage 03 that is used for recording a sample 09. The optical unit 02 is preferably designed as an objective lens. The sample 09, as illustrated in FIG. 1, may be centrally situated on the sample stage 03. Alternatively, the sample 09 may be positioned on the sample stage 03 in some other way. An angle θ is spanned between an optical axis 04 of the optical unit 02 and a plane 05 extending perpendicularly with respect to the sample stage 03. The angle θ may be adjusted to change the perspective of the optical unit 02. The optical unit 02 may be adjusted, preferably via a tiltable microscope stand (not shown) that supports the optical unit, in order to adjust the angle θ. Alternatively, the angle θ may be varied by tilting the sample stage 03.

A sample plane generally extends perpendicularly with respect to the optical axis 04 or parallel to the sample stage 03. The optical unit 02 may include optical components and an image sensor in the so-called Scheimpflug configuration. In this case, the sample plane extends parallel to the sample stage 03 for all angles θ.

While the method according to the invention is being carried out, the angle θ is changed multiple times in order to record images of the sample 09 with various perspectives. Multiple individual images of the sample are hereby recorded for each perspective at various focus positions. FIG. 1 shows the extended depth of field (EDoF) that is achievable by the focus variation, in comparison to the depth of field (DoF) that is possible without focus variation. The described method for generating a three-dimensional model of a sample has been successfully tested by recording the sample at the following angles θ: −45°, −30°, −15°, 0°, 15°, 30°, and 45°. For each perspective, an image with an extended depth of field or an elevation map may be subsequently computed from the recorded individual images. The image with an extended depth of field or the elevation map that is computed in each case together with information concerning the perspective used is stored in a memory. A three-dimensional model of the sample may subsequently be computed from the computed images with an extended depth of field or the elevation maps. Alternatively, the three-dimensional model of the sample may be computed directly from the individual images recorded for the various perspectives. In this case, the step in which an image with an extended depth of field or an elevation map is initially computed in each case from the individual images recorded for each perspective is omitted. The indicated angles θ are by way of example only, and other angles are certainly possible.

One advantageous embodiment of the optical unit 02 utilizes an optical actuator designed as a microsystem with mechanically movable micromirrors for recording an extended depth of field. In this embodiment, for example the above-described MALS module from SD Optics, Inc. may be used as the optical actuator. A MALS module may be designed as a Fresnel lens, for example, as described in WO 2005/119331 A1, for example. This Fresnel lens is formed from a plurality of micromirrors. The focal length of the Fresnel lens may be changed very quickly by changing the position of the micromirrors. This rapid change in the focal length allows a very quick adjustment of the focus plane to be imaged. This allows a plurality of recordings to be made in adjacent focus planes within a short time.

FIG. 2 shows a schematic illustration of a second embodiment of the digital microscope 01 in two different image recording positions. In this embodiment, the sample stage 03 may be displaced at least in the X direction to allow the position of the sample 09 relative to the optical axis 04 to be changed, and to allow recordings of different areas of the sample 09 in the visual field of the optical unit 02 to be made. FIG. 2 illustrates two different positions of the sample stage 03. The distance Xv between the optical axis 04 and the plane extending through the center of the sample 09 perpendicular to the sample stage is shown to be greater in the left illustrated position of the sample stage 03 than in the right illustrated position of the sample stage 03. The distances Xv are selected in such a way that the recordings of the sample overlap in adjacent areas. Recordings for these overlap areas are then present from different perspectives, and the computation of three-dimensional models is made possible.

The described method for generating a three-dimensional model of a sample was carried out at the following distances between the plane 05 and the optical axis 04: −20 mm, −10 mm, 0 mm, 10 mm, 20 mm. Here as well, there is no limitation to the stated distances. Multiple individual images of the sample 09 at various focus positions are once again recorded in each position of the sample stage 03 to allow computation of images with an extended depth of field (EDoF) or elevation maps.

FIG. 3 shows a schematic illustration of a third embodiment of the microscope 01. This embodiment utilizes a ring light illuminator 07 that emits a light cone 08 for illuminating the sample 09.

The ring light illuminator 07 is illustrated in detail in FIG. 4. It includes multiple illumination means 10 that may be selectively switched on to allow sequential illumination of the sample 09 at different angular distributions. The illumination means 10 are preferably designed as LEDs. FIG. 4 shows three diagrams with three different switching states of the ring light illuminator 07. The illumination means 10 that is switched on in the particular switching state is illustrated in crosshatch. In each illumination situation, multiple individual images of the sample 09 are recorded at different focus positions, so that here as well, an extended depth of field (EDoF) may be achieved or elevation maps may be computed.

The methods explained with reference to FIGS. 1 through 3 may also be combined with one another.

1. A method for generating a three-dimensional model of a sample using a microscope, comprising the following steps:
a. specifying a perspective for recording of images of at least one area of the sample, wherein the perspective is specified by the angle and the position of the optical axis of the objective lens relative to the sample, and by the angular distribution of the illumination radiation relative to the sample;
b. recording multiple individual images of the area of the sample at various focus positions from the specified perspective;
repeating steps a. and b. for the at least one area of the sample with at least one further different perspective;
computing a three-dimensional model of the area of the sample from the recorded individual images of the area of the sample.

2. The method according to claim 1, wherein in the computation of the three-dimensional model, initially an image with an extended depth of field or an elevation map is computed in each case from the individual images of the area of the sample that are recorded for each specified perspective, and the three-dimensional model of the area of the sample is subsequently computed from the computed images with an extended depth of field or the elevation map.

3. The method according to claim 1, wherein incorrectly computed pixels of the three-dimensional model of the sample are eliminated by applying an estimation algorithm.

4. The method according to claim 1, wherein the three-dimensional model of the sample is computed using a stereogrammetry algorithm and/or an epipolar geometry algorithm.

5. The method according to claim 1, wherein the various perspectives are achieved by swiveling a microscope stand, an image sensor, or an optical axis.

6. The method according to claim 1, wherein the various perspectives are achieved by displacing a sample stage in the X and/or Y direction and/or rotating and/or tilting the sample stage.

7. The method according to claim 6, wherein swiveling of the sample stage takes place by means of a drive device.

8. The method according to claim 1, wherein the various perspectives are designed as illumination perspectives, wherein the various illumination perspectives are achieved by sequential illumination of the sample.

9. The method according to claim 8, wherein a horizontal angle for illuminating the sample is variable from 0° to 360°.

10. The method according to claim 9, wherein the sequential illumination of the sample takes place by means of a ring light illuminator.

11. The method according to claim 1, wherein at least two three-dimensional models of the sample are computed, wherein the various perspectives for each of the three-dimensional models are achieved in different ways, and/or a different algorithm is used for computing each of the three-dimensional models, and the computed three-dimensional models are combined into an end model.

12. The method according to claim 8, wherein a weighted assessment of the computed three-dimensional pixels of the end model takes place.

13. The method according to claim 1, one of claims 1 to 12, wherein an optical actuator that is designed as a microsystem with mechanically movable micromirrors is used for rapidly recording multiple individual images at various focus positions.

14. A digital microscope wherein it is configured for carrying out the method according to claim 1.

15. The digital microscope according to claim 14, with an optical actuator that is designed as a microsystem with mechanically movable micromirrors for recording an extended depth of field.
